(19) United States
(12) Patent Application Publication
(10) Pub. No.: US 2024/0116366 A1
(43) Pub. Date: Apr. 11, 2024

(54) MOTOR DRIVE SYSTEM AND CONTROL METHOD OF SAME

(71) Applicants: Hyundai Motor Company, Seoul (KR); Kia Corporation, Seoul (KR)

(72) Inventors: Seung Hyeon BIN, Hwaseong-Si (KR); Byung Oh Tak, Hwaseong-Si (KR); Seong Min Kim, Changwon-Si (KR); Ho Rim Choi, Hwaseong-Si (KR)

(73) Assignees: Hyundai Motor Company, Seoul (KR); Kia Corporation, Seoul (KR)

(21) Appl. No.: 18/144,743

(22) Filed: May 8, 2023

(30) Foreign Application Priority Data
Oct. 11, 2022 (KR) 10-2022-0129809

(51) Int. Cl. B60L 3/00; B60L 15/20; H02P 5/74; H02P 27/06

(52) U.S. Cl. CPC B60L 3/003; B60L 15/20; H02P 5/74; H02P 27/06; B60L 2240/421; B60L 2240/423; B60L 2240/80

(57) ABSTRACT

In a control method of a motor drive system, when a first motor corresponding to a first drive wheel is being driven in a second drive mode among a first drive mode in which the first motor is driven by a first inverter of the motor drive system and connected to a first end of each of coils of the first motor and the second drive mode in which the first motor is driven by the first inverter and a second inverter connected to a second end of each of the coils and configured to selectively operate, whether or not the second inverter malfunctions is determined. When the second inverter malfunctions, a drive mode is changed so that the first motor is driven in the first drive mode. An output limit of the first motor in the first drive mode is relaxed.

### CROSS REFERENCE TO RELATED APPLICATION

The present application claims priority to Korean Patent Application No. 10-2022-0129809, filed on Oct. 11, 2022, the entire contents of which is incorporated herein for all purposes by this reference.

### BACKGROUND OF THE PRESENT DISCLOSURE

### Field of the Present Disclosure

The present disclosure relates generally to a motor drive system and a control method of the same, wherein a first motor corresponding to a first drive wheel is configured to be driven by selecting a drive mode associated with a single inverter or a drive mode associated with a plurality of inverters, and when one of the plurality of inverters connected to the first motor malfunctions, output power of the first motor is adjusted.

### Description of Related Art

Recently, as research and development of eco-friendly vehicles have been actively carried out for environmental preservation, efforts for improving dynamic performance and energy efficiency of eco-friendly vehicles have been made. In general, such an eco-friendly vehicle generates driving force of the vehicle by driving a motor using energy stored in an energy storage device, such as a battery, and thus is essentially provided with inverters converting power from a battery into power required for driving a motor.

In general, coils for each of phases of a motor are configured (to have a Y connection) so that one end of each of the coils is connected to one inverter and the other ends thereof are connected. In driving of the motor, a switching element in the inverter is turned on or off by pulse width modulation (PWM) control to apply a voltage to the Y-connected coils of the motor to generate AC current, causing the motor to generate torque.

However, when the Y-connected motor rotates, back electromotive force is generated. Because back electromotive force increases with increases in the revolutions per minute (RPM) of the motor, maximum power of the motor is limited, degrading acceleration performance of the vehicle, which is problematic. Furthermore, as the number of windings of each coil of the motor is increased to increase maximum torque of the motor, a section with high voltage utilization may be further spaced from a low torque area, lowering fuel efficiency.

Thus, a motor driving technology capable for improving system efficiency while covering both a low power range and a high power range using a single motor is required. Recently, a technology of driving a single motor in two different modes using two inverters and a mode transfer switch has been introduced. The plurality of coils of the motor may have an open winding configuration, with one end of each of the coils being connected to a first inverter, and the end of each of the coils being connected to a second inverter. A mode in which the transfer switch is turned on in the low power range so that the motor operates in a Y-connected arrangement may be referred to as a closed end winding (CEW) mode, and a mode in which the transfer switch is turned off in the high power range so that the motor operates in the open winding configuration may be referred to as an open end winding (OEW) mode.

However, when the second inverter connected to the other ends of the plurality of coils malfunctions while the motor is operating in the OEW mode, it is impossible to synthesize a phase voltage of the motor for generating torque and a current instruction in response to a driver's desired output. Because it is impossible to control current due to the malfunction of the second inverter, the driver's desired output cannot be met.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a motor drive system and a control method of the same, wherein a first motor corresponding to a first drive wheel is configured to be driven by selecting a drive mode associated with a single inverter or a drive mode associated with a plurality of inverters, and when one of the plurality of inverters connected to the first motor malfunctions, output power of the first motor is adjusted to meet driver's desired output power.

The objective of the present disclosure is not limited to the aforementioned description, and other objectives not explicitly included herein will be clearly understood by those skilled in the art from the description provided hereinafter.

In various aspects of the present disclosure, there is provided a control method of a motor drive system. The control method may include: when a first motor corresponding to a first drive wheel is being driven in a second drive mode among a first drive mode in which the first motor is driven by a first inverter of the motor drive system and connected to a first end of each of coils of the first motor and the second drive mode in which the first motor is driven by the first inverter and a second inverter connected to a second end of each of the coils and configured to selectively operate, determining whether or not the second inverter malfunctions; when the second inverter malfunctions, changing a drive mode of the motor drive system so that the first motor is driven in the first drive mode; and relaxing an output limit of the first motor in the first drive mode.

The determination of whether or not the second inverter malfunctions may include determining whether or not the second inverter malfunctions based on whether or not the second inverter operates according to a pulse width modulation (PWM) signal input to the second inverter in operation in the second drive mode.

The changing of the drive mode may include: when second inverter malfunctions, stopping controlling the second inverter; and causing the second end of each of the coils of the first motor to be short-circuited.

The relaxation of the output limit of the first motor may include adjusting an upper limit of torque of the first motor to a second torque higher than a predetermined first torque of the first motor according to revolutions per minute (rpm) for at least some RPM range in the first drive mode.

The adjustment of the upper limit of torque may include maintaining the adjusted upper limit of torque for a predetermined time period.

The predetermined time period may be set to be a second time longer than a first time applied to a specific drive mode in which the adjusted upper limit of torque is used.

The adjustment of the upper limit of torque may include outputting warning information caused by the adjusting of the upper limit of torque.

The relaxation of the output limit of the first motor may include relaxing an output limit of a second motor of the motor drive system and corresponding to a second drive wheel.

One end of each of coils of the second motor may be connected to a third inverter and the second end of each of the coils of the second motor may be connected to each other.

The relaxation of the output limit of the first motor may further include distributing a target torque to the first motor and the second motor based on whether or not the output limit of each of the first motor and the second motor is relaxed.

According to one aspect of the present disclosure, there is provided a motor drive system including: a first motor corresponding to a first drive wheel and including a plurality of coils; a first inverter connected to a first end of each of the coils of the first motor; a second inverter connected to a second end of each of the coils of the first motor and configured to selectively operate; and a first controller configured to control the first inverter and the second inverter. When the second inverter is detected as malfunctioning when the first motor is being driven in a second drive mode among a first drive mode in which the first motor is driven by the first inverter and the second drive mode in which the first motor is driven by the first inverter and the second inverter, the first controller may change a drive mode of the motor drive system so that the first motor is driven in the first drive mode and relaxes an output limit of the first motor in the first drive mode.

The first controller may be configured to determine whether or not the second inverter malfunctions based on whether or not the second inverter operates according to a pulse width modulation (PWM) signal input to the second inverter in operation in the second drive mode.

When second inverter malfunctions, the first controller may stop controlling the second inverter and cause the second end of each of the coils of the first motor to be short-circuited.

The motor drive system may further include a second controller configured to adjust an upper limit of torque of the first motor to a second torque higher than a predetermined first torque of the first motor according to an RPM for at least some RPM range in the first drive mode. The first controller may relax@ the output limit of the first motor based on the upper limit of the torque of the first motor adjusted by the second controller.

The second controller may maintain the adjusted upper limit of torque for a predetermined time period.

The second controller may output warning information caused by the adjusting of the upper limit of torque.

The first controller may relax an output limit of a second motor of the motor drive system and corresponding to a second drive wheel.

The second controller may distribute target torque to the first motor and the second motor based on whether or not the output limit of each of the first motor and the second motor is relaxed.

In the motor drive system and the control method of the same according to an exemplary embodiment of the present disclosure, when the first motor is driven in a drive mode associated with the first inverter due to the malfunction of the second inverter connected to the first motor to selectively operate, upper limits of torque of the first motor and the second motor corresponding to first drive wheels and second drive wheels of the vehicle may be adjusted to meet acceleration performed desired by the driver.

Effects obtainable from the present disclosure are not limited to the aforementioned effects, and other effects not explicitly included herein will be clearly understood by those skilled in the art from the description provided hereinafter.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram illustrating a motor drive system according to various exemplary embodiments of the present disclosure;

FIG. 2 is a circuit diagram corresponding to a first motor, according to various exemplary embodiments of the present disclosure;

FIG. 3 is a circuit diagram corresponding to a second motor, according to various exemplary embodiments of the present disclosure;

FIG. 4 is a graph illustrating upper limit data of torque corresponding to the RPM of the motor according to the drive mode of the motor according to various exemplary embodiments of the present disclosure;

FIG. 5 is a block diagram illustrating a plurality of controllers configured to control the motor drive system according to various exemplary embodiments of the present disclosure;

FIG. 6 is a graph illustrating upper limit data of torque in which limits corresponding to the RPM according to the drive mode of the motor are relaxed according to various exemplary embodiments of the present disclosure; and

FIG. 7, FIG. 8 and FIG. 9 are flowcharts illustrating a control method of a motor drive system according to various exemplary embodiments of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

In the description of the present disclosure, when it is determined that the detailed description of related art would obscure the gist of the present disclosure, the detailed description thereof will be omitted. Furthermore, the attached drawings are merely intended to be able to readily understand the exemplary embodiments disclosed herein, and thus the technical idea disclosed herein is not limited by the attached drawings, and it should be understood to include all changes, equivalents, and substitutions included in the idea and technical scope of the present disclosure.

It will be understood that, although terms “first”, “second”, etc., may be used herein to describe various elements, these elements should not be limited by these terms. These terms are only used to distinguish one element from another element.

It will be understood that when an element is referred to as being “coupled”, “connected”, or “linked” to another element, it may be directly coupled or connected to the other element or intervening elements may be present therebetween. In contrast, it should be understood that when an element is referred to as being “directly coupled”, “directly connected”, or “directly connected” to another element, there are no intervening elements present.

As used herein, singular forms are intended to include the plural forms as well, unless the context clearly indicates otherwise.

It will be further understood that terms “comprise”, “include”, “have”, etc., when used in the present specification, specify the presence of stated features, integers, steps, operations, elements, components, and/or combinations thereof but do not preclude the presence or addition of one or more other features, integers, steps, operations, elements, components, and/or combinations thereof.

Hereinafter, embodiments included in the present disclosure will be described in detail with reference to the accompanying drawings, in which identical or similar constituent elements are provided the same reference numerals regardless of the reference numerals of the drawings, and a repeated description thereof will be omitted.

Furthermore, a term such as “unit” or “controller” included in names, such as a motor controller (MCU) and a vehicle controller (VCU), is only a term widely used in naming of a controller that controls a specific function of a vehicle but should not be understood as indicating a generic function unit. For example, each of the controllers may include: a communication device configured to communicate with another controller or a sensor to control unique functions of the controller; a memory storing an operating system (OS), logic instructions, input/output information, and the like; and one or more processors configured to perform determination, computation, decision required for the control of the unique functions.

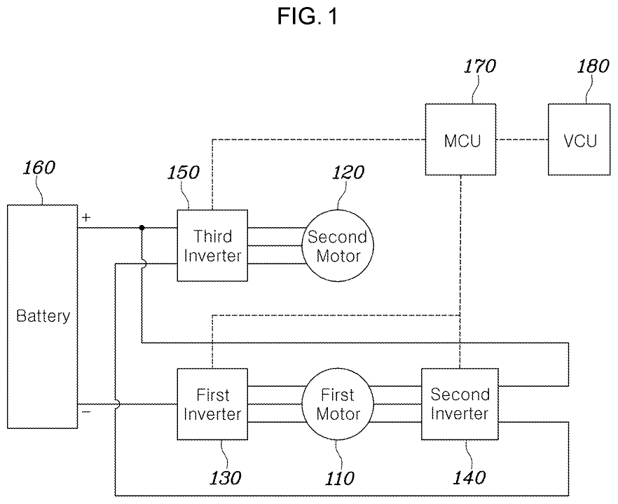

First, the configuration of a motor drive system according to various exemplary embodiments will be described with reference to FIG. 1.

FIG. 1 is a block diagram illustrating a motor drive system according to various exemplary embodiments of the present disclosure.

Referring to FIG. 1, the motor drive system according to various exemplary embodiments of the present disclosure may include: a plurality of motors 110 and 120 corresponding to drive wheels (e.g., front and rear wheels) of a vehicle; first and second inverters 130 and 140 corresponding to the first motor 110; a third inverter 150 corresponding to the second motor 120; a battery 160; a motor controller (MCU) 170; an integrated vehicle controller (VCU) 180. FIG. 1 generally illustrates components related to various exemplary embodiments of the present disclosure, and fewer or more components than those illustrated FIG. 1 may be included in actual implementation of the motor drive system.

Hereinafter, respective components will be described.

The motors 110 and 120 may be provided to correspond to the drive wheels (e.g., front and rear wheels) of the vehicle. One motor of the motors 110 and 120 may be connected to the plurality of inverters at one and the other ends of the coils. In an exemplary embodiment of the present disclosure, the first inverter 130 may be connected to one end of each of the coils of the first motor 110 corresponding to the first drive wheel, and the second inverter 140 may be connected to the other ends of the plurality of coils of the first motor 110. Furthermore, the third inverter 150 may be connected to one end of each of the coils of the second motor 120 corresponding to the second drive wheel.

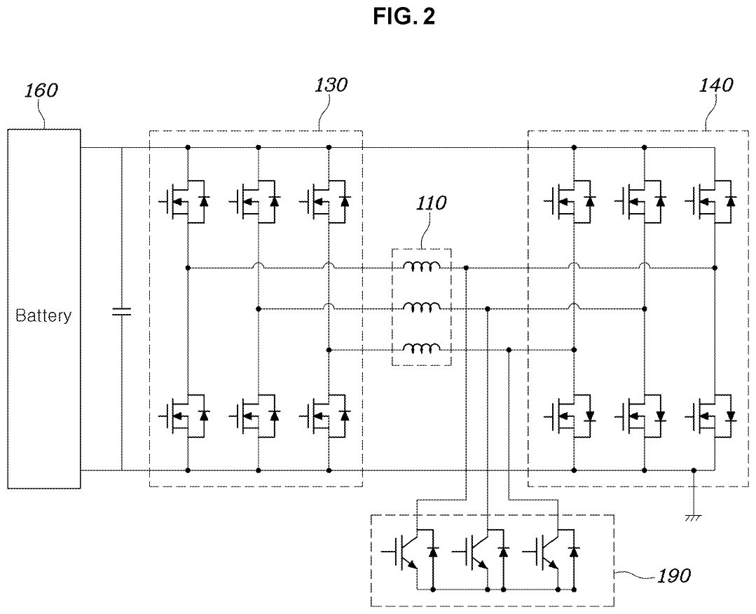

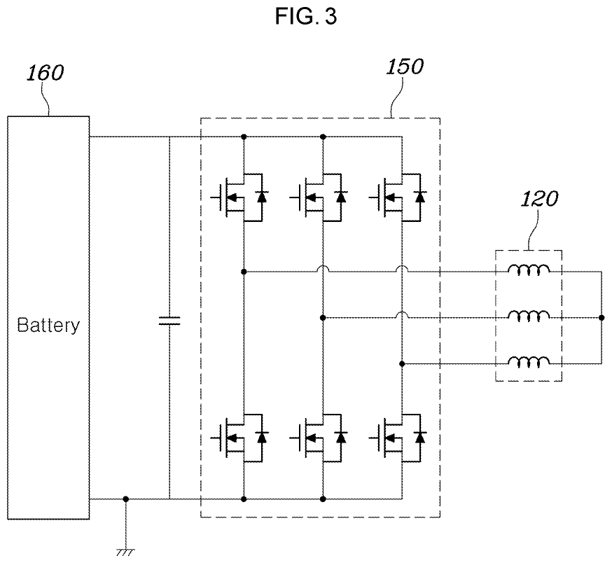

The plurality of inverters 130, 140, and 150 may be connected to the battery 160, and may provide power necessary for the motors 110 and 120 from the battery 160 depending on the drive mode of each of the motors 110 and 120. Here, the inverters 130, 140, and 150 may convert DC power output from the battery 160 into AC power and provide the resultant AC power to each of the motors 110 and 120. Hereinafter, drive modes of each of the motors 110 and 120 will be described with reference to FIG. 2 and FIG. 3.

FIG. 2 is a circuit diagram corresponding to a first motor, according to various exemplary embodiments of the present disclosure, and FIG. 3 is a circuit diagram corresponding to a second motor, according to various exemplary embodiments of the present disclosure.

Referring to FIG. 2, the first inverter 130 connected to one end of each of the coils of the first motor 110 may include a plurality of switching elements, and the second inverter 140 connected to the other ends of the plurality of coils of the first motor 110 may include a plurality of switching elements. Furthermore, a transfer switch 190 including a plurality of switching elements may be provided between the other ends of the plurality of coils of the first motor 110 and the second inverter 140. Since the transfer switch 190 is provided, whether or not to operate the second inverter 140 connected to the other ends of the plurality of coils of the first motor 110 may be selectively adjusted. Furthermore, the first inverter 130 and the second inverter 140 may convert DC power stored in the battery 160 into AC current and supply the AC power to the first motor 110. The conversion between DC power and AC power may be performed by pulse width modulation (PWM) control of the plurality of switching elements of the first inverter 130 and the second inverter 140.

In the present connection structure, when the transfer switch 190 is turned on, the other ends of the plurality of coils of the first motor 110 form a mutual electrical connection, and the first motor 110 may be driven in a first drive mode (e.g., a closed end winding (CEW) mode) in which only the plurality of switching elements of the first inverter 130 are switched by the PWM control by inactivating the second inverter 140. When the transfer switch 190 is turned off, both ends of each of the coils of the first motor 110 are electrically connected to the first inverter 130 and the second inverter 140, respectively, and the first motor 110 may be driven in a second drive mode (e.g., an open end winding (OEW) mode).

Referring to FIG. 3, the third inverter 150 may be connected to one end of each of the coils of the second motor 120. The third inverter 150 may include a plurality of switching elements including the same configuration as the switching elements of the first inverter 130 or the second inverter 140. However, because the other ends of the plurality of coils of the second motor 120 are connected to each other, the second motor 120 may be driven in the first drive mode (e.g., the CEW mode). Although the first drive mode has the same name as the first drive mode in which the first motor 110 is driven in a state in which the first motor 110 is connected to the first inverter 130, there may be a difference between torque output from the first motor 110 and torque output from the second motor 120 in the first drive mode.

Furthermore, referring to FIG. 2 and FIG. 3, the circuit diagrams illustrating to the first motor 110 and the second motor 120 may be provided to correspond to respective drive wheels of the vehicle. For example, the circuit diagram corresponding to the first motor 110 may correspond to the front wheels of the vehicle, and the circuit diagram corresponding to the second motor 120 may correspond to the rear wheels of the vehicle. However, this is for illustrative purposes only, and the drive wheels corresponding to respective motors may vary. Furthermore, although a plurality of batteries 160 may be provided to correspond to the plurality of motors 110 and 120, respectively, power may be supplied to each of the motors 110 and 120 using a single battery 160.

Returning to FIG. 1, the MCU 170 may control a gate drive unit based on of the angle, phase voltage, phase current, desired torque, and the like of each of the motors 110 and 120 using a control signal in a form of a PWM control signal, and the gate drive unit may responsively control the inverters 130, 140, and 150 that drive the motors 110 and 120. The MCU 170 may be configured to determine the drive mode of each of the motors 110 and 120, and generate a current command corresponding to each of the drive modes and output the current command in a form of a PWM control signal. For example, when the first motor 110 or the second motor 120 is driven in the CEW mode, the MCU 170 may control the first inverter 130 or the third inverter 150 as a PWM control signal corresponding to the CEW mode. Furthermore, when the first motor 110 is driven in the OEW mode, the first and second inverters 130 and 140 may be controlled using a PWM control signal corresponding to the OEW mode.

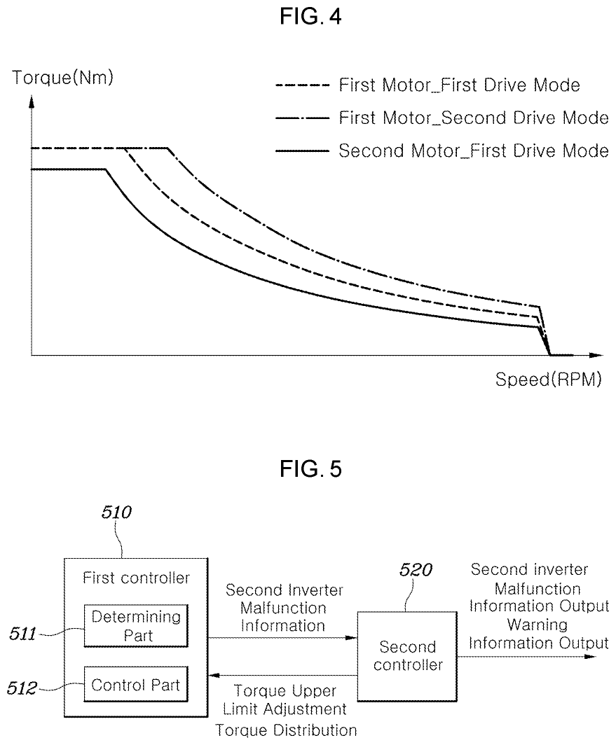

The VCU 180 may be configured to determine a value of desired driving force according to the APS value of an accelerator pedal position sensor (APS). The VCU 180 determines desired torque that the motors 110 and 120 are supposed to share to meet the desired driving force, and transfers a resultant torque command to the MCU 170. Furthermore, the VCU 180 may check the state of the battery 160 and determine final driving torque to be output by the motors 110 and 120 according to the state of the battery 160. Here, the VCU 180 may be configured to determine driving torque of each of the motors based on of torque data according to predetermined RPMs of the motors. This will be described with reference to FIG. 4.

FIG. 4 is a graph illustrating upper limit data of torque corresponding to the RPM of the motor according to the drive mode of the motor according to various exemplary embodiments of the present disclosure.

Referring to FIG. 4, there may be different upper limits of torque in specific RPM sections according to the drive mode of the first motor 110 or the second motor 120. The upper limit curve of the first drive mode of the first motor 110 or the second motor 120 illustrated in the graph indicates a reference output limit of the first motor 110 or the second motor 120, and may be predetermined in consideration of the durability, the degree of heat generation, and the degree of current control of each of the motors or each of the inverters connected to the motors. In driving of a vehicle, the torque of the first motor 110 or the second motor 120 driven in the first drive mode cannot exceed corresponding torque on the upper limit curve of the first drive mode predetermined according to the RPM. The VCU 180 may also control drive torque of the first motor 110 or the second motor 120 on the present basis.

The VCU 180 may perform torque distribution to the first motor 110 and the second motor 120 according to driver's desired torque within the range not exceeding torque corresponding to the upper limit curves of the first drive mode of the first motor 110 and the second motor 120. In the instant case, when the driver desires an amount of torque exceeding torque corresponding to the upper limit curve of the first drive mode, there may be a problem in that the first motor 110 and the second motor 120 fail to meet the desired torque. This may be solved by causing the first motor 110 connected to the inverters 130 and 140 to be driven in the second drive mode. As the first motor 110 operates in the second drive mode, the first motor 110 may have output limits defined by the upper limit curve of the second drive mode illustrated in FIG. 4. In the second drive mode, the first motor 110 may be connected to the first and second inverters 130 and 140 to increase a synthesizable voltage in comparison to the first drive mode, increasing output power. Thus, the first motor 110 driven in the second drive mode may obtain output power greater than power output in the first drive mode. Consequently, torque that the first motor 110 may produce or support may be increased in comparison to the first drive mode. Thus, the VCU 180 may perform torque distribution to the first motor 110 and the second motor 120 to meet the driver's desired torque.

However, when the second inverter 140 connected to the first motor 110 malfunctions, the drive mode of the first motor 110 cannot be converted into the second drive mode, and the first motor 110 may be driven in the first drive mode through the transfer switch 190. In the instant case, the upper limit of output power of the first motor 110 may be lowered, failing to the driver's desired torque, which is problematic. To solve the present problem, in an exemplary embodiment of the present disclosure, the driver's desired torque is met by relaxing the output limits of the first motor 110 and the second motor 120 driven in the first drive mode. A configuration of the controller serving to relax the output limits of the first motor 110 and the second motor 120 driven in the first drive mode will be described as follows with reference to FIG. 5.

FIG. 5 is a block diagram illustrating a plurality of controllers configured to control the motor drive system according to various exemplary embodiments of the present disclosure.

Referring to FIG. 5, a plurality of controllers 510 and 520, each configured to perform a control process, may be provided. The control of the motor drive system according to various exemplary embodiments of the present disclosure may be performed by cooperative control of the plurality of first and second controllers 510 and 520.

The first controller 510 according to various exemplary embodiments of the present disclosure may control the first inverter 130 connected to one end of each of the coils of the first motor 110 and the second inverter 140 selectively connectable to the other end of each of the coils of the first motor 110. Furthermore, when the second inverter 140 is detected as malfunctioning while the first motor 110 is being driven in the second drive mode, the first controller 510 may change the drive mode so that the first motor 110 is driven in the first drive mode and relax the output limit of the first motor 110 in the first drive mode. In this regard, the first controller 510 may include a determining portion 511 and a control portion 512.

The determining portion 511 in the first controller 510 may be configured to determine whether or not the second inverter 140 malfunctions while the first motor 110 is being driven in the second drive mode. When the first motor 110 is being driven in the second drive mode, the determining portion 511 may be configured to determine whether or not the second inverter 140 malfunctions based on of whether or not the second inverter 140 operates according to a PWM signal input to the second inverter 140.

When the determining portion 511 determines the second inverter 140 malfunctions, the first motor 110 may not be further driven in the second drive mode, and the control portion 512 may change the drive mode so that the first motor 110 is driven in the first drive mode. For example, when the second inverter 140 malfunctions, the control portion 512 may stop controlling the second inverter 140 and control the transfer switch 190 to cause the other ends of the plurality of coils of the first motor 110 to be short-circuited. By causing the other ends of the plurality of coils of the first motor 110 to be short-circuited, the drive mode of the first motor 110 may be changed to the first drive mode connected to the first inverter 130.

Furthermore, the control portion 512 may relax the output limit of the first motor 110 in the first drive mode. Here, the control portion 512 may adjust the upper limit of torque of the first motor 110 through the second controller 520 and relax the output limit of the first motor 110 based on of the adjusted upper limit of torque. Furthermore, the control portion 512 may relax the output limit of not only the first motor 110 but also the second motor 120 in the first drive mode. For example, the control portion 512 may be configured to generate a current command so that the output limit of the first motor 110 is relaxed to the upper limit of torque adjusted by the second controller 520, and transfer the generated current command to the first inverter 130 connected to the first motor 110. Also for the second motor 120, the control portion 512 may be configured to generate a current command so that the output limit of the second motor 120 is relaxed to the upper limit of torque adjusted by the second controller 520, and transfer the generated current command to the third inverter 150 connected to the second motor 120. The control portion 512 may meet the driver's desired output by relaxing the output limits of the first motor 110 and the second motor 120, improving acceleration performance of the vehicle.

As described above, cooperative control of the first controller 510 and the second controller 520 may be performed to relax the output limit of the first motor 110. When the second inverter 140 malfunctions, the first controller 510 may transfer malfunction information of the second inverter 140 to the second controller 520, and the second controller 520 may output the malfunction information transferred thereto so that the driver may be notified of whether or not the second inverter 140 malfunctions.

For example, the malfunction information or warning information of the second inverter may be transferred to the driver as an audio signal, an image, or text through an output device. Here, the output device may include a display device able to visually output the shape of the image or the text, a speaker able to output audios, and the like. The display device may be implemented as a display of a cluster or an audio video navigation (AVN) system. However, this is for illustrative purposes only, and a variety of other methods of transferring the information to the driver through the output device may be variously applied.

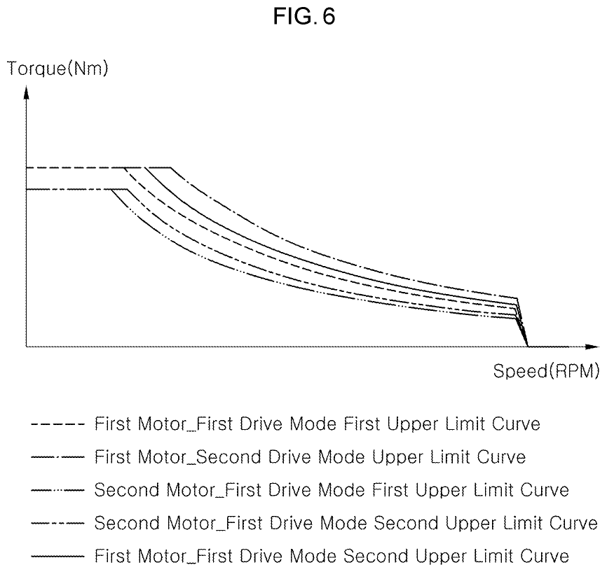

Furthermore, when the second inverter 140 malfunctions, the second controller 520 may adjust the upper limits of torque of the first motor 110 and second motor 120. For example, for at least some RPM range in the first drive mode, the second controller 520 may adjust the upper limit of torque of the first motor 110 to second torque higher than first torque of the first motor 110 predetermined according to the RPM. The adjustment of the upper limit of torque will be described as follows with reference to FIG. 6.

FIG. 6 is a graph illustrating upper limit data of torque in which limits corresponding to the RPM according to the drive mode of the motor are relaxed according to various exemplary embodiments of the present disclosure.

Referring to FIG. 6, the torque upper limit data of the first motor 110 or the second motor 120 according to the RPM may be stored in the second controller 520. In some RMP ranges, a plurality of pieces of torque upper limit data may be stored. For example, in some RPM ranges, the plurality of pieces of torque upper limit data corresponding to the drive modes of the first motor 110 may be stored. A first upper limit curve in driving in the first drive mode may include predetermined first torque of the first motor 110. When the second inverter 140 does not malfunction, the first motor 110 may include the upper limit of torque included in the upper limit curve of the second drive mode of the first motor 110 illustrated in the graph. However, when driving in the second drive mode is not performed due to the malfunction of the second inverter 140, driving in the first drive mode may be performed so that the upper limit of torque is lower than the upper limit of torque when driving in the second drive mode. Thus, the driver's desired torque that has been met while the first motor 110 is being driven in the second drive mode may not be met since the drive mode is lowered to the first drive mode.

Thus, the second controller 520 may include a plurality of upper limit curves of torque in the first drive mode. A second upper limit curve in driving in the first drive mode may include the second torque higher than the first torque of the first motor 110. This may be equally applied to the second motor 120, and the second controller 520 may adjust third torque corresponding to the first upper limit curve of the second motor 120 to fourth torque corresponding to the second upper limit curve of the second motor 120. Thus, the adjustment of the upper limit of torque of the first motor 110 or the second motor 120 by the second controller 520 may mean changing the first upper limit curve to the second upper limit curve in driving of the first motor 110 or the second motor 120 in the first drive mode.

When the second inverter 140 malfunctions, the second controller 520 may change the first upper limit curve in driving of the first motor 110 or the second motor 120 in the first drive mode to the second upper limit curve, and transfer changed information to the first controller 510. The control portion 512 of the first controller 510 may be configured to generate a current command based on of the information transferred from the second controller 520 so that the output limit of the first motor 110 or the second motor 120 is relaxed. The first controller 510 may control the driving of the first motor 110 or the second motor 120 based on of the generated current command. Here, the relaxation of the output limit may be performed for a predetermined time period, and the second controller 520 may provide the driver with information warning that available output power of the first motor 110 or the second motor 120 may be reduced after the predetermined time period.

In another exemplary embodiment of the present disclosure, when the upper limit of torque of the first motor 110 or the second motor 120 is adjusted, the second controller 520 may maintain the adjusted upper limit of torque for a predetermined time period. Here, the predetermined time period may indicate a second time longer than a first time applied to a specific drive mode in which the adjusted upper limit of torque is used.

In adjustment of the upper limit of torque of the first motor 110 or the second motor 120, the output limit may be relaxed to the second upper limit curve having higher output limits than the first upper limit curve predetermined in the range in which none of the durability, the degree of heat generation, and the degree of current control of the motor or the inverter is impaired. Here, in the instant case of relaxation of the output limit, the second upper limit curve may be configured so as not to exceed output potential determined by design parameters of the motor or the inverter, and the output limit may be relaxed only for the predetermined first time to prevent the motor or the inverter from being overloaded. For example, a boost mode of the vehicle may be considered. When the driver desires the boost mode using an input device provided in the vehicle, the output limit of the motor may be relaxed for a predetermined time period to increase the acceleration of the vehicle than in conventional driving. Here, this is only an example for better understanding of the output limit of the motor being relaxed from the first upper limit curve to the second upper limit curve, but is not limited to a case in which the second upper limit curve corresponds to the boost mode.

However, when the driver continuously desires high output power, the second controller 520 may meet the driver's desired output by performing a control operation so that the adjusted upper limit of torque is maintained for the second time longer than the predetermined first time. In the instant case, however, the motor may be overheated by excessive maintaining of the upper limit of torque. Thus, the second controller 520 may control the output device to output information warning of overheating of the motor.

In another exemplary embodiment of the present disclosure, the second controller 520 may distribute the driver's desired torque to the first motor 110 and the second motor 120 based on of whether the output limit of each of the first motor 110 and the second motor 120 is relaxed. The first controller 510 may be configured to determine the possibility of relaxing the output limit by determining the state of each of the first motor 110 and the second motor 120. That is, whether or not the adjusted upper limit of torque is applicable to the first motor 110 and the second motor 120 may be determined. Thus, the first controller 510 determine whether or not the adjusted upper limit of torque is applicable to the first motor 110 and the second motor 120 and transfer the result of the determination to the second controller 520.

Furthermore, when the adjusted upper limit of torque is inapplicable to one of the first motor 110 and the second motor 120, the second controller 520 may distribute driver's desired torque so that a motor to which the adjusted upper limit of torque is applicable may be imparted with a weight value and loaded with a greater amount of torque than a motor to which the adjusted upper limit of torque is inapplicable. Furthermore, the second controller 520 may output information warning that available output of the first motor 110 or the second motor 120 may be reduced after a predetermined time period due to excessive relaxation of the output limit of the first motor 110 or the second motor 120.

In implementation of the first controller 510 and the second controller 520, the first controller 510 may be the MCU 170, and the second controller 520 may be the VCU 180. However, this is for illustrative purposes only, and the present disclosure is not limited thereto. For example, the first controller 510 may be implemented so that functions thereof are distributed to two or more different controllers, and different functions of the first controller 510 and the second controller 520 are not limited to the above teachings of the detailed description. For example, the upper limit of torque may be adjusted through the upper limit curve of torque of the motor by the first controller 510.

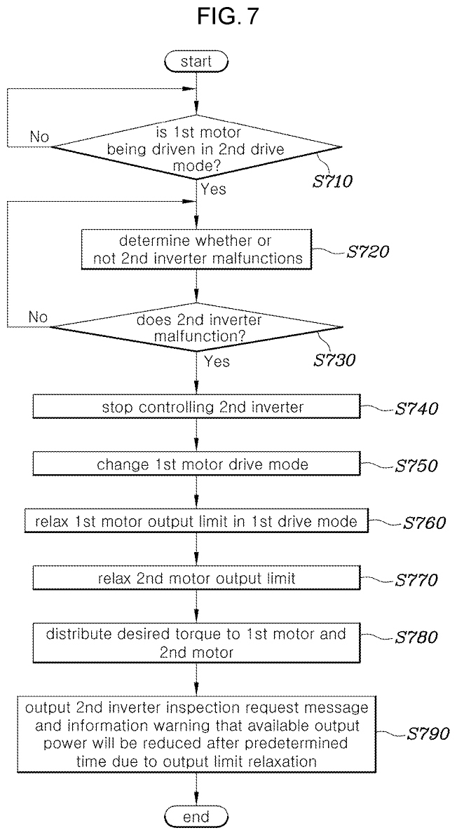

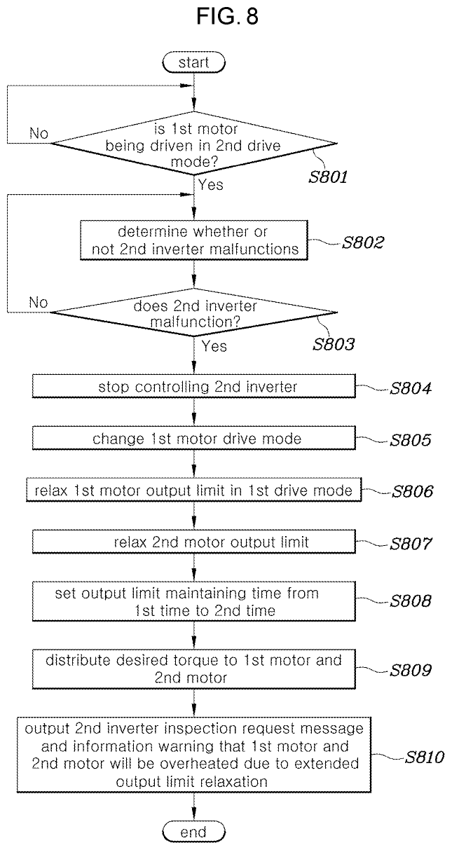

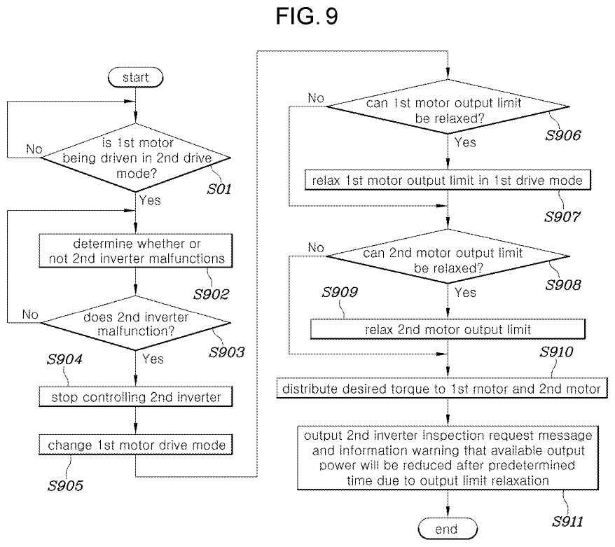

Hereinafter, a control method of a motor drive system according to various exemplary embodiments will be described based on of the configuration of the motor drive system described above with reference to FIGS. 1 to 6. In FIGS. 7 to 9, it will be assumed that the first controller 510 and the second controller 520 illustrated in FIG. 5 are implemented as the MCU 170 and the VCU 180, respectively, for the sake of brevity.

FIG. 7, FIG. 8 and FIG. 9 are flowcharts illustrating the control method of a motor drive system according to various exemplary embodiments of the present disclosure.

First, referring to FIG. 7, when the first motor 110 is being driven in the second drive mode as indicated with Yes in S710, the MCU 170 may be configured to determine whether or not the second inverter 140 malfunctions in S720. When the second inverter 140 malfunctions as indicated with Yes in S730, the MCU 170 may stop controlling the second inverter 140 in S740.

After controlling the second inverter 140 is stopped the MCU 170 may change the drive mode through the transfer switch 190 so that the first motor 110 is driven in the first drive mode in S750. Afterwards, the MCU 170 may relax the output limit of the first motor 110 in the first drive mode by adjusting the upper limit of torque of the first motor 110 by the VCU 180 in S760. Furthermore, the MCU 170 may relax the output limit of the second motor 120 by adjusting the upper limit of torque of the second motor 120 by the VCU 180 in S770.

The MCU 170 may provide information regarding the first motor 110 and the second motor 120, the output limits of which are relaxed, to the VCU 180, and the VCU 180 may distribute desired torque to the first motor 110 and the second motor 120 in S780.

After the torque of the first motor 110 and the torque of the second motor 120 are adjusted, the MCU 170 may transfer malfunction information of the second inverter 140 to the VCU 180. Furthermore, the VCU 180 may output an inspection request caused by the malfunction of the second inverter 140 and information warning that available output power may be reduced after a predetermined time period due to the relaxation of the output limits of first motor 110 and the second motor 120 in S790.

FIG. 8 is a flowchart illustrating a control method of a motor drive system according to another exemplary embodiment of the present disclosure.

Referring to FIG. 8, steps S801 to S807 in FIG. 8 are the same as the steps S710 to S770 described above with reference to FIG. 7, and thus descriptions of the steps S801 to S807 will be omitted.

After the step S807, the VCU 180 may relax the output limit of first motor 110 and the output limit of second motor 120 by changing a related output limit maintaining time from a predetermined first time to a second time longer than the first time in S808. Accordingly, the MCU 170 may relax the output limits of first motor 110 and the output limit of second motor 120 for the second time, and the VCU 180 may responsively distribute desired torque to the first motor 110 and the second motor 120 in S809.

Afterwards, the VCU 180 may be configured to generate inspection request information caused by the malfunction of the second inverter 140 and information warning that the first motor 110 and the second motor 120 may be overheated due to extended output limit relaxation for the second time longer than the predetermined first time and provide the generated information to the driver in S810.

FIG. 9 is a flowchart illustrating a control method of a motor drive system according to another exemplary embodiment of the present disclosure.

Referring to FIG. 9, steps S901 to S905 in FIG. 9 are the same as the steps S710 to S750 described above with reference to FIG. 7, and thus descriptions of the steps S901 to S905 will be omitted.

After the step S905, the MCU 170 may be configured to determine whether or not the first motor 110 may be driven by relaxing the output limit thereof in S906. When the first motor 110 may be driven by relaxing the output limit thereof as indicated with Yes in S906, the MCU 170 may relax the output limit of the first motor 110 in the first drive mode by the VCU 180 in S907. Furthermore, the MCU 170 may be configured to determine whether or not the second motor 120 may be driven by relaxing the output limit thereof in S908. When the second motor 120 may be driven by relaxing the output limit thereof as indicated with Yes in S908, the MCU 170 may relax the output limit of the second motor 120 in S909.

When the first motor 110 is not driven by relaxing the output limit thereof as indicated with No in S906 or the second motor 120 is not driven by relaxing the output limit thereof as indicated with No in S908, the VCU 180 may distribute desired torque to the first motor 110 and second motor 120 in consideration of the states of the first motor 110 and second motor 120 in S910.

The following step S911 is the same as the step S790 described above with reference to FIG. 7, and thus a description of the step S911 will be omitted.

Furthermore, in FIGS. 7 to 9, the process of transferring the malfunction information of the second inverter 140 from the MCU 170 to the VCU 180 is not necessarily performed after the adjustment of torque of the motors. For example, after the MCU 170 determines whether or not the second inverter 140 malfunctions, when the second inverter 140 is determined to malfunction, the MCU 170 may transfer the malfunction information of the second inverter 140 to the VCU 180.

Furthermore, although steps of determining whether or not to relax the output limits of the first motor 110 and the second motor 120 are illustrated as being sequentially performed in FIG. 9, this is not limitative. For example, the above-described steps S906 and S908 may be performed by performing the relaxation of the output limits of the first motor 110 and the second motor 120. Thus, the step S906 of determining whether or not relax the output limit of the first motor 110 and the step S908 of determining whether or not relax the output limit of the second motor 120 may be simultaneously performed.

Although the exemplary embodiments of the present disclosure have been described for illustrative purposes, those skilled in the art will appreciate that various modifications, additions, and substitutions are possible, without departing from the scope and spirit of the present disclosure as defined in the accompanying claims.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by multiple control devices, or an integrated single control device.

In various exemplary embodiments of the present disclosure, the scope of the present disclosure includes software or machine-executable commands (e.g., an operating system, an application, firmware, a program, etc.) for facilitating operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A control method of a motor drive system, the control method comprising:
when a first motor corresponding to a first drive wheel is being driven in a second drive mode among a first drive mode in which the first motor is driven by a first inverter of the motor drive system and connected to a first end of each of coils of the first motor and the second drive mode in which the first motor is driven by the first inverter and a second inverter connected to a second end of each of the coils and configured to selectively operate, determining whether the second inverter malfunctions;
changing a drive mode of the motor drive system so that the first motor is driven in the first drive mode when the second inverter malfunctions; and
relaxing an output limit of the first motor in the first drive mode.

2. The control method of claim 1, wherein the determining of whether the second inverter malfunctions includes determining whether the second inverter malfunctions based on whether the second inverter operates according to a pulse width modulation (PWM) signal input to the second inverter in operation in the second drive mode.

3. The control method of claim 2, wherein the changing of the drive mode includes:
stopping controlling the second inverter when the second inverter malfunctions; and
causing the second end of each of the coils of the first motor to be short-circuited.

4. The control method of claim 1, wherein the relaxing of the output limit of the first motor includes adjusting an upper limit of torque of the first motor to a second torque higher than a predetermined first torque of the first motor according to revolutions per minute (rpm) for a predetermined RPM range in the first drive mode.

5. The control method of claim 4,
wherein the motor drive system further includes a second controller configured to adjust the upper limit of torque of the first motor to the second torque higher than the predetermined first torque of the first motor according to the RPM for the predetermined RPM range in the first drive mode, and
wherein the motor drive system further includes a first controller configured to relax the output limit of the first motor based on the upper limit of the torque of the first motor adjusted by the second controller.

6. The control method of claim 4, wherein the adjusting of the upper limit of torque includes maintaining the adjusted upper limit of torque for a predetermined time period.

7. The control method of claim 6, wherein the predetermined time period is set to be a second time longer than a first time applied to a drive mode in which the adjusted upper limit of torque is used.

8. The control method of claim 4, wherein the adjusting of the upper limit of torque includes outputting warning information caused by the adjusting of the upper limit of torque.

9. The control method of claim 1, wherein the relaxing of the output limit of the first motor includes relaxing an output limit of a second motor corresponding to a second drive wheel.

10. The control method of claim 9, where a first end of each of coils of the second motor is connected to a third inverter of the motor drive system and a second end of each of the coils of the second motor are connected to each other.

11. The control method of claim 9, wherein the relaxation of the output limit of the first motor further includes distributing a target torque to the first motor and the second motor based on whether the output limit of each of the first motor and the second motor is relaxed.

12. A motor drive system comprising:
a first motor corresponding to a first drive wheel and including a plurality of coils;
a first inverter connected to a first end of each of the coils of the first motor;
a second inverter connected to a second end of each of the coils of the first motor and configured to selectively operate; and
a first controller configured to control the first inverter and the second inverter,
wherein, when the second inverter is detected as malfunctioning when the first motor is being driven in a second drive mode among a first drive mode in which the first motor is driven by the first inverter and the second drive mode in which the first motor is driven by the first inverter and the second inverter, the first controller is configured to change a drive mode of the motor drive system so that the first motor is driven in the first drive mode and to relax an output limit of the first motor in the first drive mode.

13. The motor drive system of claim 12, wherein the first controller is further configured to determine whether the second inverter malfunctions based on whether the second inverter operates according to a pulse width modulation (PWM) signal input to the second inverter in operation in the second drive mode.

14. The motor drive system of claim 13, wherein, when the first controller concludes that the second inverter malfunctions, the first controller is further configured to stop controlling the second inverter and cause the second end of each of the coils of the first motor to be short-circuited.

15. The motor drive system of claim 12, further including a second controller configured to adjust an upper limit of torque of the first motor to a second torque higher than a predetermined first torque of the first motor according to an RPM for a predetermined RPM range in the first drive mode,
wherein the first controller is further configured to relax the output limit of the first motor based on the upper limit of the torque of the first motor adjusted by the second controller.

16. The motor drive system of claim 15, wherein the second controller is further configured to maintain the adjusted upper limit of torque for a predetermined time period.

17. The motor drive system of claim 15, wherein the second controller is further configured to output warning information caused by the adjusting of the upper limit of torque.

18. The motor drive system of claim 12, wherein the first controller is further configured to relax an output limit of a second motor corresponding to a second drive wheel.

19. The motor drive system of claim 18, wherein the second controller is further configured to distribute target torque to the first motor and the second motor based on whether the output limit of each of the first motor and the second motor is relaxed.

20. The motor drive system of claim 18, where a first end of each of coils of the second motor is connected to a third inverter of the motor drive system and a second end of each of the coils of the second motor are connected to each other.
